(19) United States
(12) Patent Application Publication
(10) Pub. No.: US 2025/0145513 A1
(43) Pub. Date: May 8, 2025

(54) METHOD FOR GLASS FORMATION AND MORPHOLOGY OF PRODUCTS MADE FROM NON-EQUILIBRIUM LIQUIDS BY PROCESSING IN REDUCED GRAVITY

(71) Applicant: MATERIALS DEVELOPMENT, INC., ARLINGTON HEIGHTS, IL (US)

(72) Inventors: Johann Richard WEBER, Arlington Heights, IL (US); Stephen Kenneth WILKE, Evanston, IL (US)

(73) Assignee: MATERIALS DEVELOPMENT, INC., ARLINGTON HEIGHTS, IL (US)

(21) Appl. No.: 18/934,758

(22) Filed: Nov. 1, 2024

Related U.S. Application Data
(60) Provisional application No. 63/547,768, filed on Nov. 8, 2023.

(51) Int. Cl. C03B 19/00; C03C 11/00

(52) U.S. Cl. CPC C03B 19/00; C03C 11/00

(57) ABSTRACT

Methods of making a product of glass or other amorphous material by processing a liquid in an environment with a gravity acceleration less than the normal gravity acceleration on Earth. Methods of forming glass at different gravity levels control the distribution of second phases, such as bubbles, voids or additional glassy phases of similar or different composition.

### CROSS-REFERENCE TO RELATED APPLICATION

This application claims the benefit of U.S. Provisional Application, Ser. No. 63/547,768, filed on 8 Nov. 2023. The co-pending provisional application is hereby incorporated by reference herein in its entirety and is made a part hereof, including but not limited to those portions which specifically appear hereinafter.

### GOVERNMENT SUPPORT CLAUSE

This invention was made with government support under grant numbers 80NSSC18K0059 and 80NSSC19K1288 awarded by the U.S. National Aeronautical and Space Administration. The government has certain rights in the invention.

### FIELD OF THE INVENTION

This invention relates generally to glass and glass-product formation, and more particularly to making a product including glass or other amorphous material by processing a liquid in an environment with a gravity acceleration less than the normal gravity acceleration on Earth.

### SUMMARY OF THE INVENTION

A general object of the invention is to provide a method of glass formation in low gravity environments.

The invention includes a method of making a product including glass or other amorphous material, by processing a liquid in an environment with a gravity acceleration less than the normal gravity acceleration on Earth. The invention further includes products made according to these methods. Exemplary materials for use in this invention include, without limitation, metal oxides, such as titanium dioxide, neodymium oxide. Other materials that can be made into glass according to embodiments include a calcium silicate (CaSiO₃ with up to 4 wt % iron oxide), calcium aluminate (Ca₂Al₁₄O₃₃ with up to 4 wt % iron oxide), and lanthanum-ytterbium aluminate. The compositions that contain calcium are similar to naturally occurring regolith and metallurgical slags used to process ferrous metals.

In embodiments of this invention, pieces of the material used are heated with a laser beam to increase their temperature to above the equilibrium melting point of the crystalline starting material. When they are completely molten, the liquid is cooled by turning the heating laser beam off. The liquid then cools to room temperature. As a practical matter, heating could be performed using any heat source including a laser beam, heat lamps, a furnace or solar heating.

Materials that crystallize show a thermal arrest or even a temperature spike as the heat of crystallization is released. Liquids that cool without crystallizing and form a glass or amorphous material do not show a thermal arrest.

In embodiments, the method is performed where the gravity acceleration is 5-99% of the normal gravity acceleration on Earth.

In embodiments, the method is performed where the gravity acceleration is equal to or less than 5% of the normal gravity acceleration on Earth.

In embodiments, the method is performed where the gravity acceleration is equal to or less than 1% of the normal gravity acceleration on Earth.

In embodiments, the method is performed where the gravity acceleration is equal to or less than 0.1% of the normal gravity acceleration on Earth.

In embodiments, the method includes predetermining a critical cooling rate for vitrification of the liquid material, and cooling the liquid material at the critical cooling rate or a faster rate. The liquid material can be formed into a product shape in any suitable manner before and/or during the cooling.

In embodiments, the liquid is processed without any contact with a container or other solid or liquid surface during a cooling process.

The invention further includes a method of making a glass product that contains bubbles and voids distributed inside the body of the product. The glass product is formed by cooling a liquid from above the glass transition temperature to below the glass transition temperature of the liquid material in an environment where the gravity level is less than the normal gravity level on Earth. In embodiments, the bubbles and voids are distributed in a random fashion in the interior, and in some cases on the surface of the product. In other embodiments, the bubbles and voids are distributed uniformly in the interior, and in some cases on the surface of the product. In embodiments, the liquid is processed without any contact with a container or other solid or liquid surface during the cooling process.

The invention further includes a method of making a glass product that contains more than one glass phase, such as distributed in an interior and possibly on a surface of the product material, by cooling a liquid from above the glass transition temperature to below the glass transition temperature of the liquid material in an environment where the gravity level is less than the normal gravity level on Earth. In embodiments, two glass phases are distributed in a more or less random fashion in the interior, and in some cases on a surface of the product. In other embodiments, the two glass phases are distributed more or less uniformly in the interior, and in some cases on the surface of the product. In embodiments, the liquid is processed without any contact with a container or other solid or liquid surface during the cooling process.

In embodiments, the glass phases have different chemical compositions. In other embodiments, the glass phases have essentially the same chemical compositions.

As used herein, references to “normal gravity acceleration on Earth” or simply “gravity acceleration on Earth” are to be understood to refer to the standard acceleration of gravity on Earth or the standard acceleration of free fall on Earth, often simply called “standard gravity” and typically denoted by “g”, and which is a constant defined by standard as 9.80665 m/s² (about 32.17405 ft/s²) or 9.81 m/s² for convenience.

### BRIEF DESCRIPTION OF THE DRAWINGS

FIG. 1 shows a schematic time-temperature-transformation (TTT).

FIG. 2A and FIG. 2B show cooling curves measured on Earth and in reduced gravity in the International Space Station

FIG. 3 shows high energy X-ray diffraction structure factors for glass samples processed on Earth (lower 2 curves) and in reduced gravity (upper 2 curves).

FIG. 4A shows X-ray diffraction intensity from a glass-ceramic product formed by cooling of a melt in reduced gravity.

FIG. 4B shows small-angle X-ray scattering of the glass-ceramic product of FIG. 4A.

FIG. 5A shows an X-ray tomography cross-section, representative of glass made on Earth.

FIG. 5B shows an X-ray tomography cross-section, representative of glass made in microgravity.

### DESCRIPTION OF THE INVENTION

Liquid-phase processing is widely used in industrial and other applications to modify the properties and/or structure of materials, often to add value and utility to the resulting product. Liquids are fluid and can readily flow and deform. Flow can result from mechanical agitation (e.g., mixing, stirring, etc.), by sedimentation/floating of components with different densities, and by buoyancy-driven effects that result in convection or combinations of effects. Both sedimentation and buoyancy effects arise in part due to the gravitational acceleration acting to move components with different densities relative to one and other. Typically, less dense material moves away from, and more dense material moves toward, the direction of the gravity vector. For processes operated on Earth, the prevailing gravity acceleration provides constraints on the behavior of fluid phases when they are being processed. The magnitude and extent of fluid motion and the associated heat and mass transport are affected by the gravity acceleration and the flow properties of the fluid. For example, the value of the Grashof number can be used to express the relative magnitudes of thermally-induced buoyancy and viscous forces in a liquid. Its value is proportional to the acceleration due to gravity.

This invention is directed to processing materials, specifically materials that can form glass and/or other amorphous material products, in conditions with gravity acceleration less than that on Earth. In the context of this invention, “glass” is considered to be a material that exhibits no Bragg reflection peaks in a diffraction pattern. This means that the atoms may exhibit local ordering to a distance of a few atomic diameters with no long range order of the type present in crystalline and polycrystalline materials. Glasses are considered to be amorphous materials, namely those without long range order.

Embodiments of this invention are directed to the use of different gravity levels to influence the ability to form glass and to control the distribution of second phases, such as bubbles, voids or additional glassy phases of similar or different composition. Currently, the ability to process materials in reduced gravity is expanding due to operating platforms in low Earth orbit. This is the result of the successful operation of the International Space Station that operates in low Earth orbit at an altitude of ˜400 kilometers. In addition, various commercial satellites, sounding rockets and other platforms create potential for production of specialized materials in space. Deep space exploration provides a further impetus for developing and establishing capabilities to process and manufacture materials in reduced gravity. Aspects of this invention that would have seemed to have little utility even a decade ago can now enable significant advances in the development of new materials and processes that depend on reduced gravity for their successful operation.

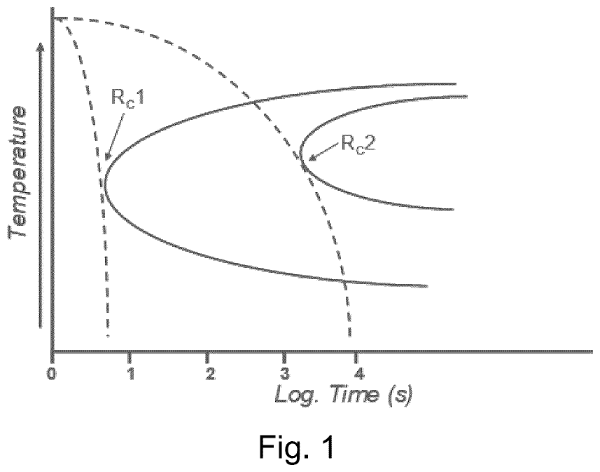

A commonly used means to produce glass and amorphous products is from liquids, often but not always molten materials. A process of supercooling or supersaturation of a liquid can be used to enter non-equilibrium states. A typical process involves cooling a liquid below its equilibrium melting temperature (supercooling or undercooling). If this supercooling continues to a sufficiently low temperature, the material can form a glass. In many cases, glass does not form due to nucleation and growth of crystals that results in the formation of crystalline materials. Frequently, a “critical cooling rate” (R_{C}) is required to prevent the nucleation and growth of crystals. Unless the liquid is cooled at R_{C} or faster, crystals are formed. These effects are illustrated in the schematic Time-Temperature-Transformation (TTT) diagram in FIG. 1.

FIG. 1 shows a schematic time-temperature-transformation (TTT), adapted from M. S. Zarabad and M. Rezvani, “Time-temperature-transformation diagrams for crystallization of the oxyfluoride glass system,” Results in Physics, 10, 356-359 (2012); and J. K. R. Weber, “The Containerless Synthesis of Glass,” Int. J. Appl. Glass Sci., 1, 248-256 (2010). The vertical axis shows temperature and the horizontal axis shows time on a logarithmic scale. Two cooling trajectories of a material are shown by the dashed lines. The first trajectory, cooling at a rate R_{C}1, passes to the left of the solid curve that represents where glass vs. crystalline products are formed (to the left and right of the solid curve). The effect of melt cooling in microgravity is represented by the sample cooling more slowly, at rate R_{C}2, which still forms a glass because the solid curve's position is shifted to the right due to gravity-associated effects.

A central element of the subject invention is that the critical cooling rate to form a glass can be influenced by the ambient gravity level. As indicated in FIG. 1, two values of R_{C}, R_{C}1 and R_{C}2 can exist. In this invention the R_{C} value in reduced gravity is smaller than it is for the same materials processed on Earth in otherwise similar conditions.

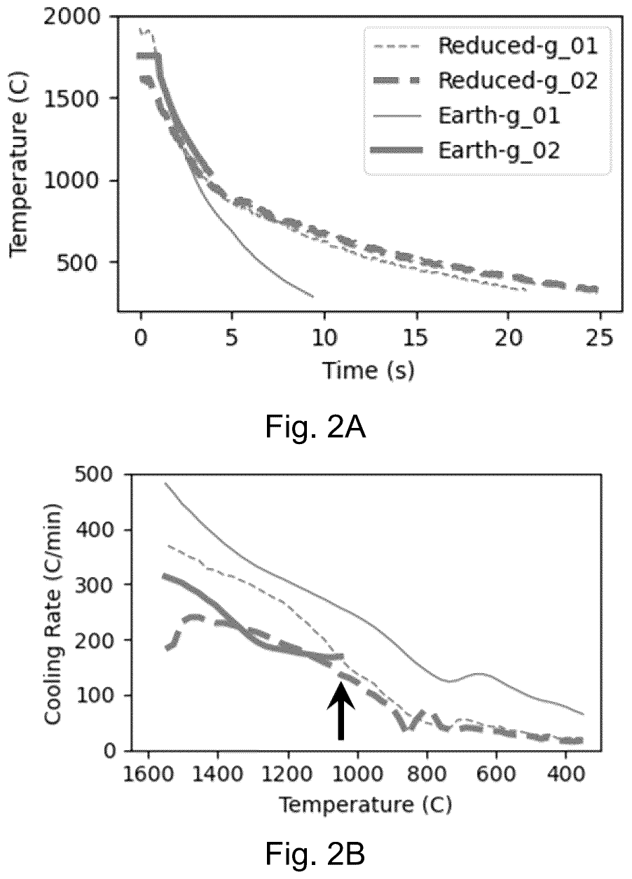

One embodiment of the invention is illustrated in FIG. 2. The figure shows temperature-time data for cooling of liquid made from a mixture of metal oxides (in this case titanium dioxide and neodymium oxide). The cooling rate required to form glass was smaller below 1050° C., in reduced gravity than on Earth.

FIG. 2A shows cooling curves measured on Earth and in reduced gravity in the International Space Station, where the gravity force is typically less than 0.1% of the value on Earth. FIG. 2B shows the corresponding cooling rates as functions of temperature. Each dataset represents a different sample, which had different masses, leading to different cooling rates. Solid curves represent samples cooled on Earth; dashed curves represent samples cooled in reduced gravity. Three of the samples cooled sufficiently fast to form glass, shown by the thin solid, thin MDI-101 dashed, and thick dashed curves. The thick solid curve was an Earth sample that crystallized spontaneously ca. 1050° C. because it cooled more slowly than the critical rate for glass formation on Earth. The sample processed in reduced gravity, shown by the thick dashed curve, formed glass even though it cooled more slowly at 1050° C. (see arrow) than the thick solid curve. This shows that the critical cooling rate for glass formation is lower in reduced gravity than on Earth.

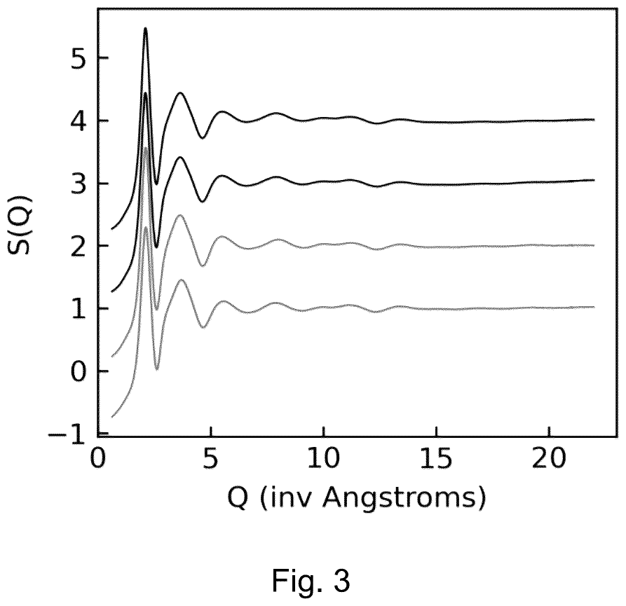

The glass samples were recovered from the measurements on Earth and in reduced gravity. The samples that cooled without showing evidence of heat release associated with crystallization were tested for crystallinity by using high energy synchrotron X-ray diffraction. This technique provides a very sensitive test for the presence of crystals. Examples of measurements on the glasses are shown in FIG. 3. No Bragg reflections were detected in the glasses.

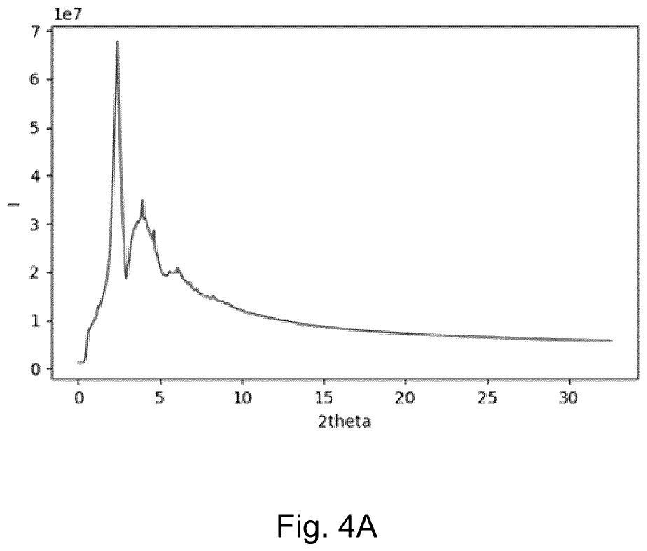

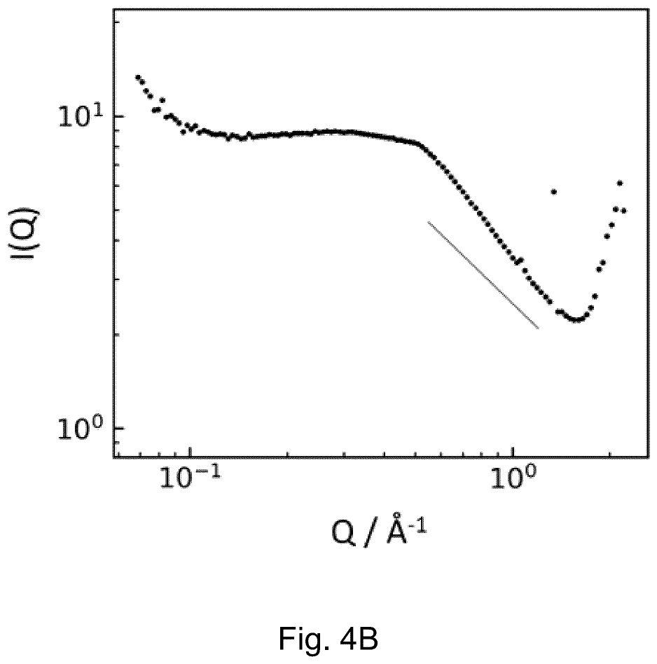

In the cooling of other melts processed in reduced gravity, part of the sample may crystallize, resulting in a glass-ceramic product. FIGS. 4A-B show the X-ray scattering observed for such a sample, which contains both glassy and crystalline phases. FIG. 4A shows X-ray diffraction intensity from a glass-ceramic product formed by cooling of a melt in reduced gravity. The presence of sharp Bragg peaks indicates the presence of crystalline domains in the product. FIG. 4B shows small-angle X-ray scattering of the same glass-ceramic product, with the linear slope between Q=0.6-1.0 Å⁻¹ indicative of the interfaces between glass and crystalline phases.

While the glasses cited as examples of embodiment of this invention are made from metal oxides, the principles will apply to other types of glass such as non-oxides, molecular glass, metallic glasses and semiconductor glasses. These may include those formed from ionic liquids, molten materials, metallic liquids and molecular liquids. In the case of molecular liquids that can be made into glass, the molecular conformality and shape influences the packing and jamming effects that can frustrate crystallization and lead to glass and amorphous products. It is therefore expected, based on the results herein, that this invention can have significant utility in the case of processing molecular glass and amorphous materials such as proteins, foods, pharmaceuticals and cosmetics. This is because mechanical deformation of molecules due to gravity-induced flow and stresses can affect molecular structure and bonding.

Further to formation of glass is the behavior of gas bubbles in samples under different gravity conditions. On Earth gas bubbles normally migrate to the top of a liquid due to the very large density difference between the gas and liquid phases. In reduced gravity, the driving force for bubble motion is smaller than on Earth. Samples made on Earth and on ISS in otherwise similar conditions were examined by white beam X-ray tomography to examine the interior structure of the material.

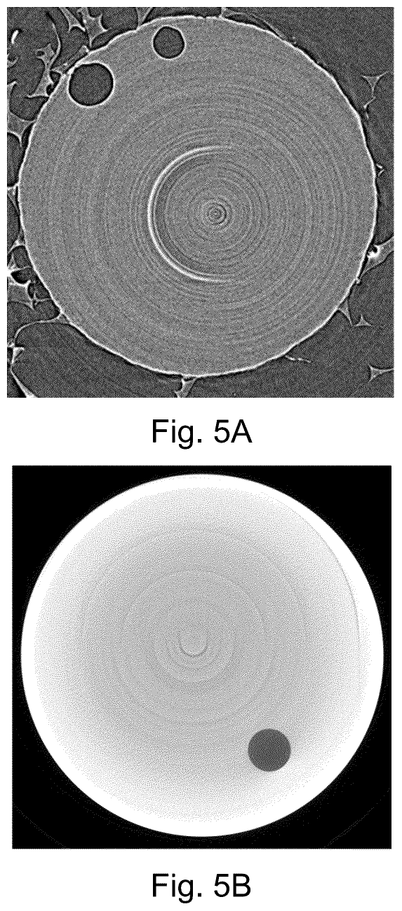

Results of measurements on glass samples according to this invention made on the ISS and on Earth are compared in FIGS. 5A and 5B. FIG. 5A shows glasses made on Earth and FIG. 5B in microgravity. Both images are cross-sections from X-ray tomography. The glass made on Earth contains bubbles that floated to the top of the melt, and were of a deformed spherical shape, so they are located at the edge of the sample. The glass made in microgravity contains an internal spherical bubble, since the lack of buoyancy results in different bubble behavior than on Earth.

By extension, it is reasonable to expect that other phases with different densities will display novel morphologies when they are processed in reduced gravity compared to what is observed for materials made on Earth. This leads to potential to make functional forms of materials by dispersing phases in a manner that provides novel properties such as light transmission or mechanical toughness.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of making a product comprising a glass or amorphous material by processing a liquid material in an environment with a gravity acceleration less than the normal gravity acceleration on Earth.

2. The method of claim 1 wherein the liquid material comprises a metal oxide.

3. The method of claim 2, wherein the gravity acceleration is less than 5% of the normal gravity acceleration on Earth.

4. The method of claim 1, wherein the gravity acceleration is 5-99% of the normal gravity acceleration on Earth.

5. The method of claim 1, wherein the gravity acceleration is less than 5% of the normal gravity acceleration on Earth.

6. The method of claim 1, wherein the liquid is processed without any contact with a container or other solid or liquid surface during a heating and cooling process.

7. The method of claim 1, further comprising:
predetermining a critical cooling rate for vitrification of the liquid material; and
cooling the liquid material at the critical cooling rate or a faster rate.

8. The method of claim 1, wherein the liquid material has a critical cooling rate for glass formation that is lower in reduced gravity than in the normal gravity acceleration on Earth, wherein the critical cooling rate in reduced gravity does not result in crystallization during the processing.

9. The method of claim 1, wherein the product shape is a rod, sphere, disc, or rectangular prism, of a size greater than 0.5 mm in dimension along two orthogonal directions.

10. The method of claim 1, wherein the product contains bubbles and/or voids distributed inside a body of the product, and the method further comprising cooling the liquid from above a glass transition temperature to below the glass transition temperature in the environment with the gravity acceleration less than the normal gravity level on Earth.

11. The method of claim 1, wherein the product includes a plurality of phases, at least one of the plurality of phases being a glass phase, and the plurality of phases are distributed in an interior and/or on a surface, the method further comprising cooling the liquid from above a glass transition temperature to below the glass transition temperature in the environment with the gravity acceleration less than the normal gravity level on Earth.

12. A method of making a product comprising a glass or amorphous metal oxide material by processing a liquid metal oxide material in an environment with a gravity acceleration less than the normal gravity acceleration on Earth.

13. The method of claim 12, wherein the gravity acceleration is less than 5% of the normal gravity acceleration on Earth.

14. The method of claim 12, wherein the gravity acceleration is 5-99% of the normal gravity acceleration on Earth.

15. The method of claim 12, further comprising:
predetermining a critical cooling rate for vitrification of the liquid material; and
cooling the liquid material at the critical cooling rate or a faster rate.

16. The method of claim 12, wherein the liquid material has a critical cooling rate for glass formation that is lower in reduced gravity than in the normal gravity acceleration on Earth, wherein the critical cooling rate in reduced gravity does not result in crystallization during the processing.

17. The method of claim 12, wherein the product shape is a rod, sphere, disc, rectangular prism, of a size greater than 0.5 mm in dimension along two orthogonal directions.

18. The method of claim 12, wherein the product contains bubbles and/or voids distributed inside a body of the product, and the method further comprising cooling the liquid from above a glass transition temperature to below the glass transition temperature in the environment with the gravity acceleration less than the normal gravity level on Earth.

19. The method of claim 12, wherein the product includes a plurality of phases, at least one of the plurality of phases being a glass phase, and the plurality of phases are distributed in an interior and/or on a surface, the method further comprising cooling the liquid from above a glass transition temperature to below the glass transition temperature in the environment with the gravity acceleration less than the normal gravity level on Earth.
